(19) United States
(12) Patent Application Publication
(10) Pub. No.: US 2009/0274211 A1
(43) Pub. Date: Nov. 5, 2009

(54) APPARATUS AND METHOD FOR HIGH QUALITY INTRA MODE PREDICTION IN A VIDEO CODER

(75) Inventors: Jian ZHOU, Fremont, CA (US); Hao-Song KONG, Sunnyvale, CA (US)

Correspondence Address: Curtis A. Vock;LATHROP & GAGE LLP, 4845 Pearl East Circle, Suite 201, Boulder, CO, 80301, US

(73) Assignee: OMNIVISION TECHNOLOGIES, INC., Sunnyvale, CA (US)

(21) Appl. No.: 12/113,197

(22) Filed: Apr. 30, 2008

(51) Int. Cl. H04N 7/32

(52) U.S. Cl. 375/240.12; 375/E07.243

(57) ABSTRACT

A computer readable storage medium has executable instructions to select a plurality of blocks in a video sequence to be coded as intra-coded blocks. Aggregate intra prediction costs are computed for each intra-coded block relative to a corresponding previous intra-coded block. An intra prediction mode is selected for each intra-coded block based on the aggregate intra prediction costs.

### FIELD OF THE INVENTION

This invention relates generally to intra mode prediction in a video coder. More particularly, this invention relates to a system and method for jointly selecting the intra prediction mode of each intra-coded block in a video sequence to improve the visual quality of the sequence.

### BACKGROUND OF THE INVENTION

Digital video coding technology enables the efficient storage and transmission of the vast amounts of visual data that compose a digital video sequence. With the development of international digital video coding standards, digital video has now become commonplace in a host of applications, ranging from video conferencing and DVDs to digital TV, mobile video, and Internet video streaming and sharing. Digital video coding standards provide the interoperability and flexibility needed to fuel the growth of digital video applications worldwide.

There are two international organizations currently responsible for developing and implementing digital video coding standards: the Video Coding Experts Group (“VCEG”) under the authority of the International Telecommunication Union—Telecommunication Standardization Sector (“ITU-T”) and the Moving Pictures Experts Group (“MPEG”) under the authority of the International Organization for Standardization (“ISO”) and the International Electrotechnical Commission (“IEC”). The ITU-T has developed the H.26x (e.g., H.261, H.263) family of video coding standards and the ISO/IEC has developed the MPEG-x (e.g., MPEG-1, MPEG-4) family of video coding standards. The H.26x standards have been designed mostly for real-time video communication applications, such as video conferencing and video telephony, while the MPEG standards have been designed to address the needs of video storage, video broadcasting, and video streaming applications.

The ITU-T and the ISO/IEC have also joined efforts in developing high-performance, high-quality video coding standards, including the previous H.262 (or MPEG-2) and the recent H.264 (or MPEG-4 Part 10/AVC) standard. The H.264 video coding standard, adopted in 2003, provides high video quality at substantially lower bit rates (up to 50%) than previous video coding standards. The H.264 standard provides enough flexibility to be applied to a wide variety of applications, including low and high bit rate applications as well as low and high resolution applications. New applications may be deployed over existing and future networks.

The H.264 video coding standard has a number of advantages that distinguish it from other existing video coding standards, while sharing common features with those standards. The basic video coding structure of H.264 is illustrated in FIG. 1. H.264 video coder 100 divides each video frame of a digital video sequence into 16×16 blocks of pixels (referred to as “macroblocks”) so that processing of the frame can be performed at a block level.

Each macroblock may be coded as an intra-coded macroblock by using information from its current video frame or as an inter-coded macroblock by using information from its previous frames. Intra-coded macroblocks are coded to exploit the spatial redundancies that exist within a given video frame through transform, quantization, and entropy (or variable-length) coding. Inter-coded macroblocks are coded to exploit the temporal redundancies that exist between macroblocks in successive frames, so that only changes between successive frames need to be encoded. This is accomplished through motion estimation and compensation.

In order to increase the efficiency of the intra coding process for the intra-coded macroblocks, spatial correlation between adjacent macroblocks in a given frame is exploited by using intra prediction 105. Since adjacent macroblocks in a given frame tend to have similar visual properties, a given macroblock in a frame may be predicted from already coded, surrounding macroblocks. The difference between the given macroblock and its prediction is then coded, which results in fewer bits to represent the given macroblock as compared to coding it directly. A block diagram illustrating intra prediction in more detail is shown in FIG. 2.

Intra prediction may be performed for the entire 16×16 macroblock or it may be performed for each 4×4 block within a macroblock. These two different prediction types are denoted by “Intra_{—}16×16” and “Intra_{—}4×4”, respectively. The Intra_{—}16×16 mode is more suited for coding very smooth areas of a video frame, while the Intra_{—}4×4 mode is more suited for coding areas of a video frame having significant detail.

In the Intra_{—}4×4 mode, each 4×4 block is predicted from spatially neighboring samples as illustrated in FIGS. 3A-3B. The 16 samples of the 4×4 block 300 which are labeled as “a-p” are predicted using prior decoded, i.e., reconstructed, samples in adjacent blocks labeled as “A-Q.” That is, block X 305 is predicted from neighboring blocks A 310, B 320, C 325, and D 315. Specifically, intra prediction is performed using data in blocks above and to the left of the block being predicted by, for example, taking the lower right pixels of the block above and to the left of the block being predicted, the lower row of pixels of the block above the block being predicted, the lower row of pixels of the block above and to the right of the block being predicted, and the right column of pixels of the block to the left of the block being predicted.

For each 4×4 block, one of nine prediction modes defined by the H.264 video coding standard may be used. The nine prediction modes are illustrated in FIG. 4. In addition to a “DC” prediction mode (Mode 2), eight directional prediction modes are specified. Those modes are suitable to predict directional structures in a video frame such as edges at various angles.

Typical H.264 video coders select one from the nine possible Intra 4×4 prediction modes according to some criterion to code each 4×4 block within an intra-coded macroblock, in a process commonly referred to as “mode decision” or “mode selection”. Once the intra prediction mode is decided, the prediction pixels are taken from the reconstructed version of the neighboring blocks to form the prediction block. The residual is then obtained by subtracting the prediction block from the current block, as illustrated in FIG. 2.

The mode decision criterion usually involves optimization of a cost to code the residual, as illustrated in FIG. 5 with the pseudo code implemented in the JM reference H.264 encoder publicly available at http://iphome.hhi.de/suehring/tml/. The cost evaluated can be a Sum of the Absolute Differences (“SAD”) cost between the original block and the predicted block, a Sum of the Square Differences (“SSE”) cost between the original block and the predicted block, or, more commonly utilized, a rate-distortion cost.

The rate-distortion cost evaluates the Lagrange cost for predicting the block with each candidate mode out of the nine possible modes and selects the mode that yields the minimum Lagrange cost. Because of the large number of available modes for coding a macroblock, the process for determining the cost needs to be performed many times. The computation involved in the coding mode decision stage is therefore very intensive.

Despite being computationally intensive, the cost optimization to decide the prediction mode(s) for a given block is typically based solely upon the previous blocks, as illustrated in FIGS. 3A-B. No impact of a given block on the following blocks is considered. As a result, the coding mode decision of each block is only locally optimized, which may not yield the best rate-distortion trade-off available for coding a given macroblock. Because the coding mode decision for each block is only locally optimized, the visual quality of the video sequence is not guaranteed to be optimal for a given rate.

Accordingly, it would be desirable to provide techniques for deciding the coding modes of all blocks in a macroblock that achieve a better rate-distortion trade-off than the current approaches.

### SUMMARY OF THE INVENTION

The invention includes a computer readable storage medium with executable instructions to select a plurality of blocks in a video sequence to be coded as intra-coded blocks. Aggregate intra prediction costs are computed for each intra-coded block relative to a corresponding previous intra-coded block. An intra prediction mode is selected for each intra-coded block based on the aggregate intra prediction costs.

An embodiment of the invention includes a method for selecting intra prediction modes for intra-coded blocks in a video sequence. Aggregate intra prediction costs associated with a plurality of intra prediction modes for each intra-coded block are computed relative to a subset of intra prediction modes for a corresponding previous intra-coded block. A subset of intra prediction modes for each intra-coded block is selected based on the aggregate intra prediction costs. An intra prediction mode from the subset of intra prediction modes for each intra-coded block that yields a smallest total aggregate intra prediction cost is determined.

Another embodiment of the invention includes a video coding apparatus having an interface for receiving a video sequence and a processor for coding the video sequence. The processor has executable instructions to select a plurality of blocks from the video sequence to be coded as intra-coded blocks and to select an intra prediction mode for each intra-coded block based on an aggregate intra prediction cost computed relative to a subset of intra prediction modes for a corresponding previous intra-coded block.

### BRIEF DESCRIPTION OF THE DRAWINGS

The invention is more fully appreciated in connection with the following detailed description taken in conjunction with the accompanying drawings, in which like reference characters refer to like parts throughout, and in which:

FIG. 1 illustrates the basic video coding structure of the H.264 video coding standard;

FIG. 2 illustrates a block diagram of intra prediction in the H.264 video coding standard;

FIG. 3A illustrates a 4×4 block predicted from spatially neighboring samples according to the H.264 video coding standard;

FIG. 3B illustrates a 4×4 block predicted from neighboring blocks according to the H.264 video coding standard;

FIG. 4 illustrates the nine Intra_{—}4×4 prediction modes of the H.264 video coding standard;

FIG. 5 illustrates pseudo-code used for the Intra_{—}4×4 coding mode decision stage of a reference H.264 encoder;

FIG. 6 illustrates a flow chart for intra mode prediction in a video coder in accordance with an embodiment of the invention;

FIG. 7 illustrates a flow chart for intra mode prediction of a current block relative to a previous block in accordance with an embodiment of the invention;

FIG. 8 illustrates the processing order for coding 4×4 blocks in an intra-coded macroblock in accordance with the H.264 video coding standard;

FIG. 9 illustrates a schematic diagram for selecting an intra prediction mode for a current block relative to a previous block in accordance with an embodiment of the invention;

FIG. 10 illustrates a schematic diagram showing coding paths between a current block and a previous block in accordance with an embodiment of the invention;

FIG. 11 illustrates a flow chart for selecting an intra prediction mode for each block in an intra-coded macroblock in accordance with an embodiment of the invention;

FIG. 12 illustrates a schematic diagram showing coding paths in a macroblock in accordance with an embodiment of the invention; and

FIG. 13 illustrates a block diagram of a video coding apparatus in accordance with an embodiment of the invention.

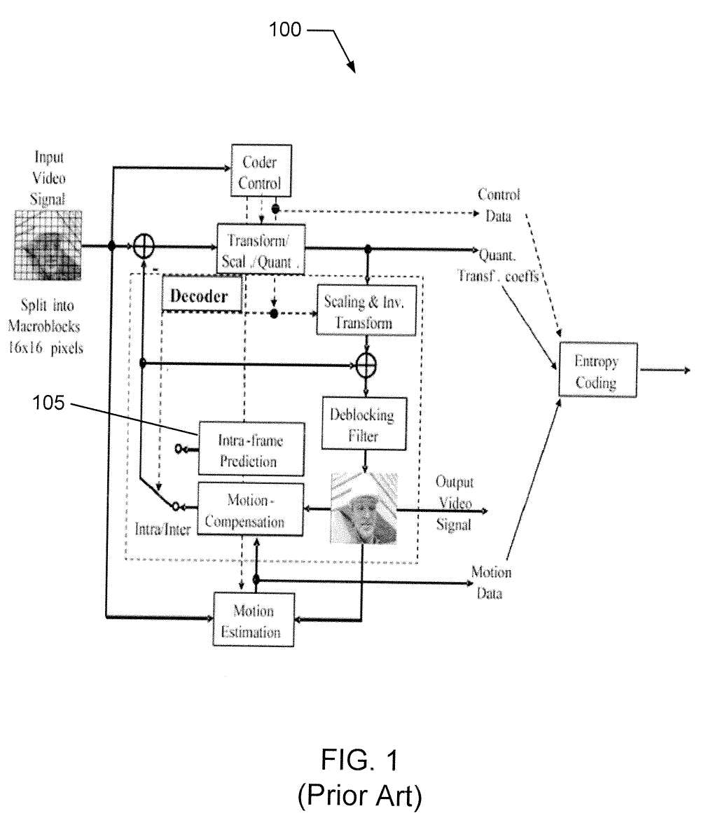

### DETAILED DESCRIPTION OF THE INVENTION

The present invention provides an apparatus, method, and computer readable storage medium for high-quality intra prediction mode selection in a video coder. As generally used herein, intra mode prediction refers to the prediction of a block in a macroblock of a digital video sequence using a given intra prediction mode. The intra prediction mode may be selected from a plurality of intra prediction modes, such as the prediction modes specified by a given video coding standard or video coder, e.g., the H.264 video coding standard, for coding a video sequence. The block may be a 4×4 block or a 16×16 block from a 16×16 macroblock, or any other size block or macroblock as specified by the video coding standard or video coder.

According to an embodiment of the invention, an intra prediction mode is selected for each block in a given intra-coded macroblock based on aggregate intra prediction costs relative to a corresponding previous block. As generally used herein, aggregate intra prediction costs refer to cumulative intra prediction costs for a current intra-coded block and its corresponding previous intra-coded block. The costs can be a Sum of the Absolute Differences (“SAD”) cost between the original block and the predicted block, a Sum of the Square Differences (“SSE”) cost between the original block and the predicted block, or, more commonly utilized, a rate-distortion cost.

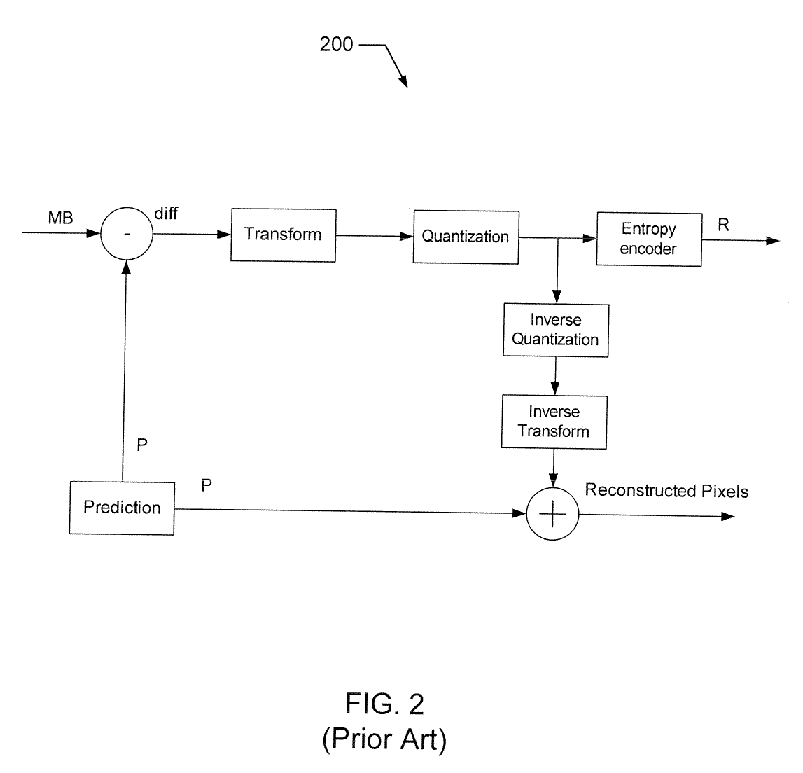

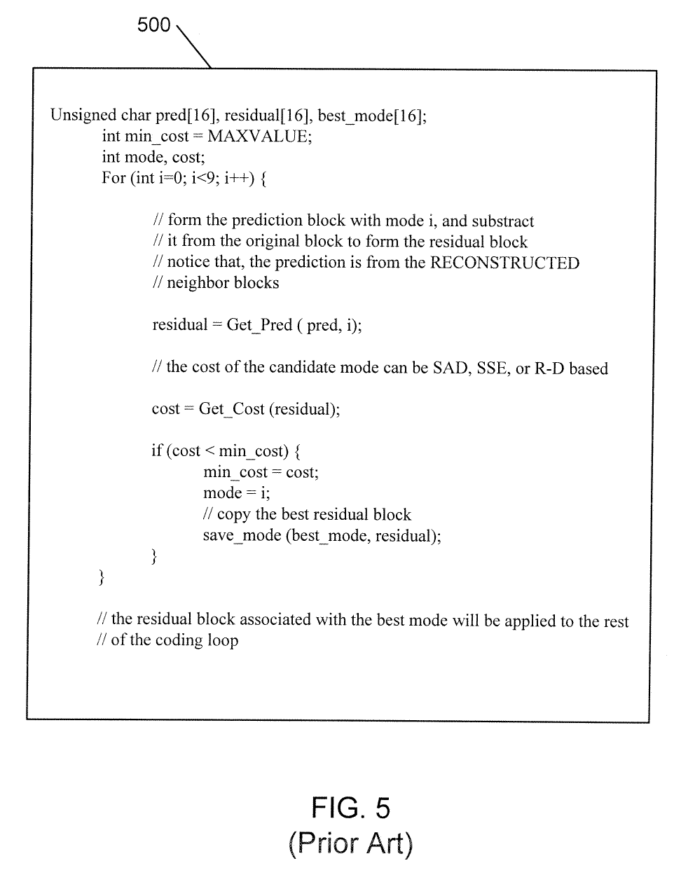

Accordingly, as generally used herein, an intra prediction cost for a given intra-coded block refer to the intra prediction cost associated with a given intra prediction mode selected for coding the block. As appreciated by one of ordinary skill in the art, the intra prediction cost for a given intra-coded block is computed by predicting the block relative to the reconstructed version of its neighboring blocks and coding the residual from the predicted block and the given block, as described above with reference to FIGS. 2 and 5.

As described in more detail herein below, a current intra-coded block and its corresponding previous intra-coded block are processed in a processing order. For example, the corresponding previous block in a macroblock for the second block to be processed in the macroblock is the first block processed in the macroblock, the corresponding previous block in a macroblock for the third block to be processed in the macroblock is the second block processed in the macroblock, the corresponding previous block for the fourth block to be processed in the macroblock is the third block processed in the macroblock, and so on. It is appreciated that the first block to be processed in the macroblock does not have a corresponding previous block. As described in more detail herein below, aggregate intra prediction costs computed for the first block in the macroblock are simply the intra prediction costs for coding the first block.

In one embodiment, intra prediction costs are computed for a subset of intra prediction modes for the corresponding previous block. The aggregate intra prediction costs for the current intra-coded block are then computed by adding the intra prediction costs for a plurality of intra prediction modes for the current intra-coded block to the intra prediction costs for the subset of intra prediction modes for the corresponding previous block.

For example, as described in more detail herein below, for a given previous block A, intra prediction costs are computed for a subset of intra prediction modes, e.g., three intra prediction modes out of a total of nine intra prediction modes such as those specified in the H.264 standard. Then, for a current block B, intra prediction costs are computed for all the intra prediction modes, e.g., for all the nine intra prediction modes. The intra prediction costs for the subset of intra prediction modes for previous block A are then added to the intra prediction costs for all the intra prediction modes for current block B to generate the aggregate intra prediction costs for the current block B.

According to an embodiment of the invention, a subset of intra prediction modes having the lowest aggregate intra prediction costs are selected for each intra-coded block. Using the example above, for current block B, a subset of, say, three, intra prediction modes are selected.

Coding paths are then formed and stored between each intra prediction mode in the subset of intra prediction modes for the corresponding previous block and a corresponding intra prediction mode for the current block. A coding path, as generally used herein, refers to an association between an intra prediction mode for coding a previous block and an intra prediction mode for coding a current block. In one embodiment, each coding path is associated with an aggregate intra prediction cost.

Using the example above and as described in more detail herein below, each intra prediction mode in the subset of intra prediction modes in current block B has a coding path to a corresponding intra prediction mode in the subset of intra prediction modes for previous block A. For example, three coding paths are formed between current block B and previous block A for three intra prediction modes in the subset of intra prediction modes.

In one embodiment, a subset of coding paths having the lowest aggregate intra prediction costs are joined from the first to the last intra-coded block in a given macroblock. The aggregate intra prediction costs for the coding paths leading the first to the last intra-coded block are then added to generate a subset of macroblock aggregate intra prediction costs. The coding path joining the first to the last intra-coded block that yields the lowest macroblock aggregate intra prediction cost is selected to determine the intra prediction mode for coding each intra-coded block in the macroblock.

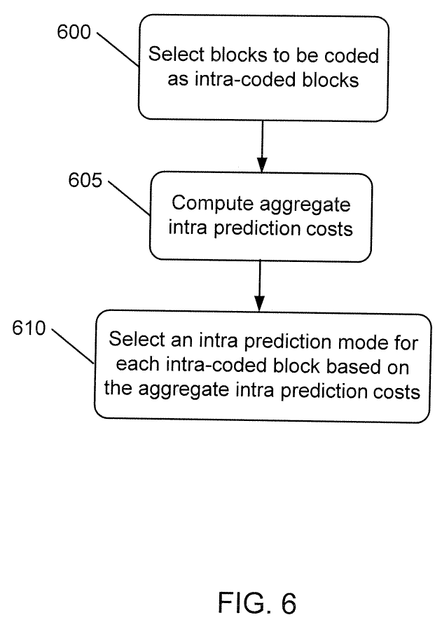

FIG. 6 illustrates a flow chart for intra mode prediction in a video coder in accordance with an embodiment of the invention. First, for a given video coding sequence, a plurality of blocks are selected to be coded as intra-coded blocks in step 600. The plurality of blocks are selected from a plurality of macroblocks in a plurality of video frames. For example, as appreciated by one of ordinary skill in the art, a given video sequence may have a plurality of frames that are intra-coded and a plurality of frames that are inter-coded. The plurality of intra-coded frames have a plurality of intra-coded macroblocks. Each intra-coded macroblock has, in turn, a plurality of intra-coded blocks.

For example, as specified in the H.264 and other like video coding standards, e.g., the MPEG family of video coding standards, a macroblock is a 16×16 macroblock having 4×4 or 16×16 intra-coded blocks. Each intra-coded block may be coded as specified in the video coding standard, such as, for example, by using intra prediction.

Next, as described in more detail herein below, aggregate intra prediction costs are computed for each intra-coded block relative to a corresponding previous intra-coded block in step 605. For example, each 16×16 macroblock has a total of 16 4×4 intra-coded blocks. Aggregate intra prediction costs for, for example, the second 4×4 intra-coded block in the 16×16 macroblock are computed relative to the first 4×4 intra-coded block in the 16×16 macroblock. That is, as described in more detail herein below, the aggregate intra prediction costs for the second 4×4 intra-coded block are computed by adding the intra prediction costs for the second 4×4 intra-coded block to the intra prediction costs for the first 4×4 intra-coded block.

It is appreciated that the intra prediction costs that are computed for each intra-coded block are the costs associated with intra prediction modes. It is further appreciated that the first intra-coded block in a given macroblock, by virtue of being the first block in the macroblock, does not have a corresponding previous block in the macroblock. Accordingly, its aggregate intra prediction costs are simply the intra prediction costs associated with intra prediction modes for predicting and coding the block.

Lastly, as described in more detail herein below, an intra prediction mode for each intra-coded block in the macroblock is selected based on the aggregate intra prediction costs in step 610. The intra prediction mode selected for each intra-coded block is selected according to an overall lowest intra prediction cost for the macroblock.

It is appreciated that, in contrast to traditional intra prediction performed in prior art approaches, the intra prediction modes selected for the macroblock are jointly selected between the blocks. That is, the selection of a prediction mode for a given block impacts the selection of the prediction mode for the immediate previous neighboring blocks. By jointly selecting the intra prediction modes for all the blocks in the macroblock, the intra mode decision is not just locally optimized as in the traditional prior art approaches, but rather, it is globally optimized for the entire macroblock.

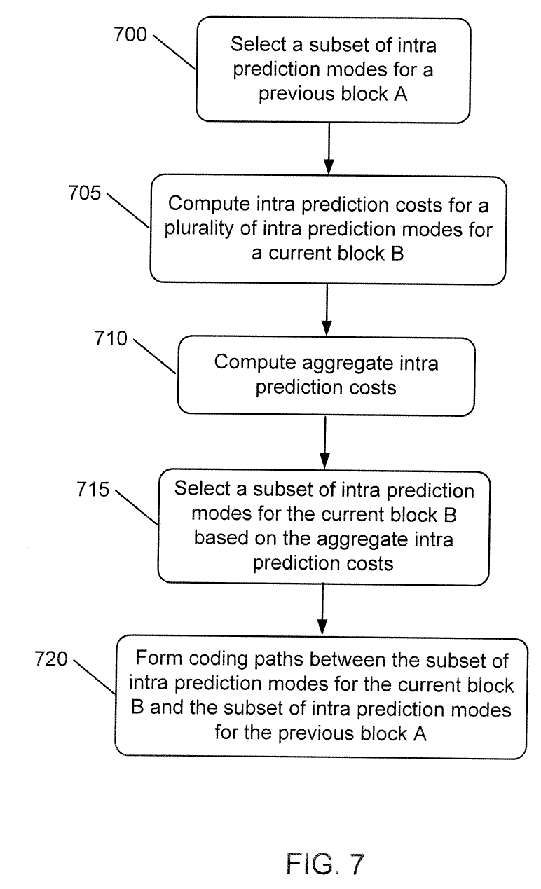

Referring now to FIG. 7, a flow chart for intra mode prediction of a current block relative to a previous block in accordance with an embodiment of the invention is described. Consider a current block B and a previous block A in a given macroblock of a video sequence. Each block in the macroblock may be coded by using one out of N intra prediction modes, where N is a number specified by the video coding standard or video coder used to code the video sequence. For example, there are a total of N =9 prediction modes available for intra-coded 4×4 blocks according to the H.264 video coding standard.

According to an embodiment of the invention, a subset of the N intra prediction modes is selected for the previous block A in step 700. The subset of intra prediction modes is formed by computing aggregate intra prediction costs for coding the previous block A with the N intra prediction modes and selecting the N intra prediction modes that yield the lowest aggregate intra prediction costs for coding the previous block A. The subset may contain, for example, M<N intra prediction modes, e.g., the subset may contain M=3 intra prediction modes.

It is appreciated that for the first block of the given macroblock, the subset of intra prediction modes contain the M prediction modes that yield the lowest intra prediction costs for coding the block. It is also appreciated that the intra prediction cost for coding the block according to a given prediction mode is computed by predicting and coding the block as described above with reference to FIGS. 2 and 5.

Next, intra prediction is conducted with N allowed prediction modes for the current block B in step 705. Notice that, for the previous block A, there are M reconstructed versions, each corresponding to one of the M selected coding modes, with each coding mode having defined neighboring information. Therefore, for current block B, each one of the N candidate modes is tried M times given different neighboring information in the previous block A. There are then M intra costs computed for each one of the N intra prediction modes for the current block B.

The aggregate intra prediction costs for coding block B are computed by adding the intra prediction costs for the N intra prediction modes for the current block B to the intra prediction costs for the subset of M intra prediction modes for coding the previous block A in step 710. It is appreciated that, only one out of the M computed costs for current block B is added to each cost for block A. That is, if one out of the M modes in previous block A (which has a cost associated with it) is used to predict current block B, a cost can be obtained with this prediction, and only these two costs are added together. In this way, M aggregate intra prediction costs are computed for each intra prediction mode out of the N intra prediction modes available for coding the current block B, resulting in a total of N×M aggregate intra prediction cost computations.

A subset of M intra prediction modes for the current block B is then selected based on the aggregate intra prediction costs in step 715. This is accomplished by selecting, for each one out of the M intra prediction modes available for coding the previous block A, a corresponding one out of the N intra prediction modes for coding the current block B that yields the lowest aggregate intra prediction cost.

Lastly, a coding path is formed and stored between each one out of the M intra prediction modes available for coding the previous block A and its corresponding one out of the N intra prediction modes for coding the current block B that yields the lowest aggregate intra prediction cost in step 720.

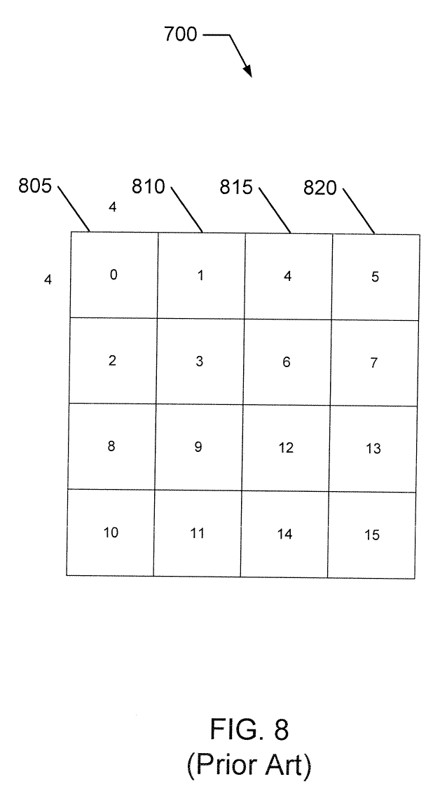

Referring now to FIG. 8, the processing order for coding 4×4 blocks in an intra-coded macroblock in accordance with the H.264 standard is described. Macroblock 800 has 16 4×4 blocks labeled from 0 to 15. The labels indicate the order in which the 4×4 blocks are processed and coded within the macroblock. For example, block 805 (labeled as block ‘0’) is coded immediately before block 810 (labeled as block ‘1’) and block 815 (labeled as block ‘4’) is coded immediately before block 820 (labeled as block ‘5’).

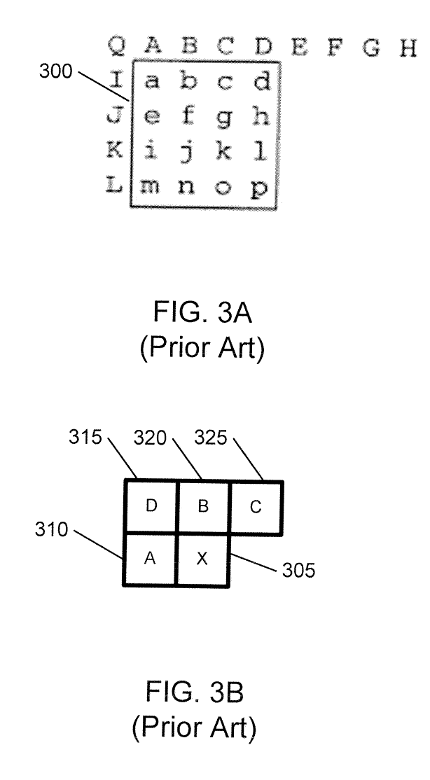

That is, block 805 is the corresponding previous block for block 810, block 810 is the corresponding previous block for block 815, block 815 is the corresponding previous block for block 820, and so on. Each block is coded with one intra prediction mode as appreciated by one of ordinary skill in the art and as described above with reference to FIGS. 2-5.

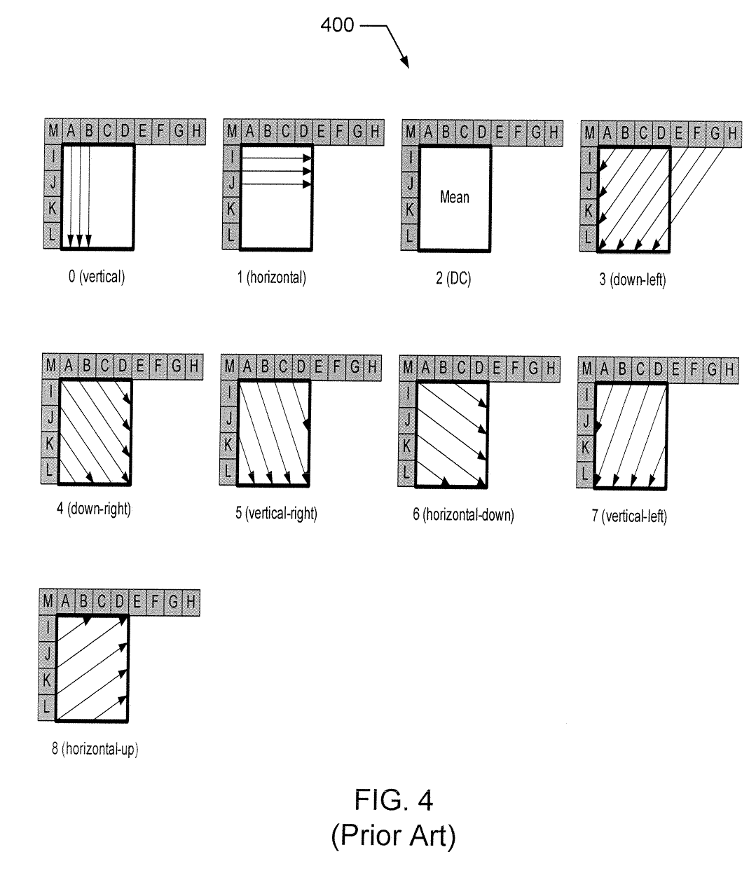

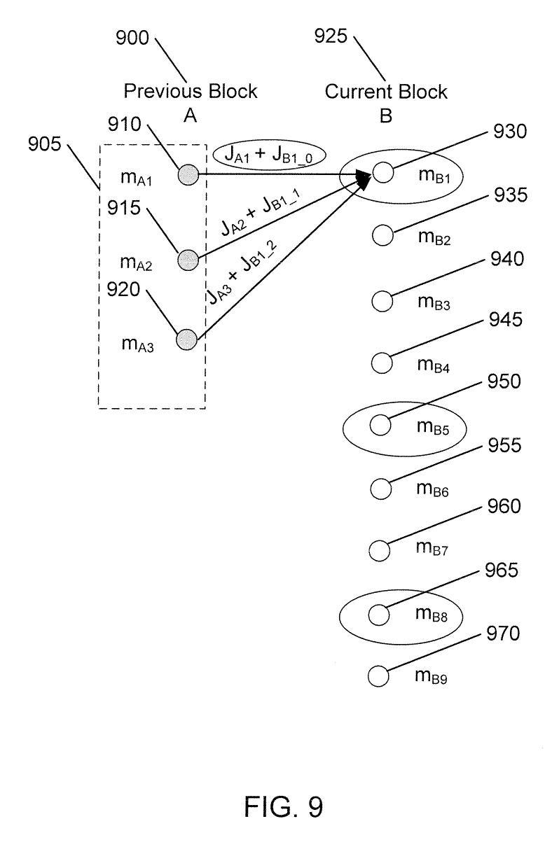

Referring now to FIG. 9, a schematic diagram for selecting an intra prediction mode for a current block relative to a previous block in accordance with an embodiment of the invention is described. Previous block A 900 is associated with a subset 905 of M intra prediction modes, which in this case, M=3. Subset 905 may contain, for example, prediction modes selected from the nine prediction modes specified by the H.264 video coding standard and illustrated in FIG. 4. Each prediction mode for previous block A 900, i.e., prediction modes m_{A1} 910, m_{A2} 915, and m_{A3} 920, has an intra prediction cost for predicting and coding previous block A 900 associated with it, i.e., intra prediction costs J_{A1}, J_{A2}, and J_{A3}.

A subset of intra prediction modes is also selected for current block B 925, as described in more detail herein above with reference to FIGS. 6-7. The selection of the M intra prediction modes in the subset is accomplished by computing intra prediction costs for all the intra prediction modes 930-970 available for coding the current block B 925, such as, for example, the nine prediction modes specified by the H.264 video coding standard, computing aggregate intra prediction costs relative to the subset of intra prediction modes 905 for the previous block A 900, and picking the M intra prediction modes that yield the lowest M aggregate intra prediction costs. In this case, for example, picking the three intra prediction modes that yield the lowest three aggregate intra prediction costs.

As illustrated, each intra prediction mode 930-970 has an M intra prediction cost associated with it, for example, intra prediction mode m_{B1} 930 has an M prediction cost J_{B1}_{_{—}}₀, J_{B1}_{_{—}}₁, and J_{B1}_{_{—}}₂ , associated with it. Aggregate intra prediction costs are computed for intra prediction mode m_{B1} 930 relative to intra prediction modes m_{A1} 910, m_{A2} 915, and m_{A3} 920 in subset 905 for previous block A 900. The aggregate intra prediction costs are computed by adding the intra prediction costs associated with the intra prediction modes, that is, by computing J_{A1}+J_{B1}_{_{—}}₀, J_{A2}+J_{B1}_{_{—}}₁, and J_{A3}+J_{B1}_{_{—}}₂.

This is done for all the intra prediction modes 930-970 for current block B 910, that is, for each one of intra prediction modes 930-970, three aggregate intra prediction costs are computed. Then, for each intra prediction mode 930-970, a corresponding intra prediction mode in subset 905 is selected as the one in the subset 905 that yields the lowest aggregate intra prediction cost. For example, intra prediction mode m_{A1} 910 is selected out of intra prediction modes 910-920 in subset 905 as the one that yields the lowest aggregate intra prediction cost for intra prediction mode m_{B1} 930.

The three intra prediction modes for current block B 925 are then selected as the ones that yield the lowest three aggregate intra prediction costs, for example, m_{B1} 930, m_{B5} 950, and m_{B8} 965. As described herein above, coding paths are then formed and stored between the subset of intra prediction modes 905 for previous block A 900 and the subset of intra prediction modes for current block B 910.

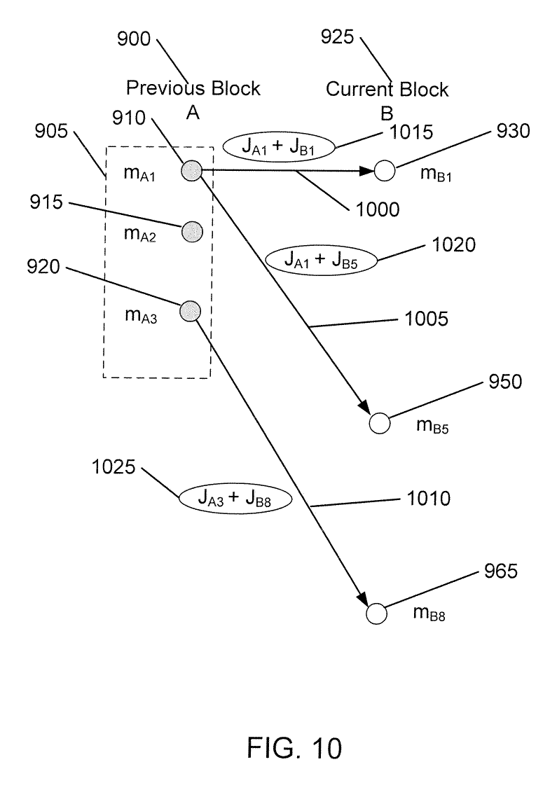

Referring now to FIG. 10, a schematic diagram showing coding paths between a current block and a previous block in accordance with an embodiment of the invention is described. Coding paths 1000-1010 are formed and stored between the subset of intra prediction modes 905 for previous block A 900 and the subset of intra prediction modes for current block B 910. Coding path 1000 is formed between intra prediction mode m_{A1} 910 for previous block A 900 and intra prediction mode m_{B1} 930 for current block B 925, coding path 1005 is formed between intra prediction mode m_{A2} 915 for previous block A 900 and intra prediction mode m_{B5} 950 for current block B 925, and coding path 1010 is formed between intra prediction mode m_{A3} 920 for previous block A 900 and intra prediction mode m_{B8} 965 for current block B 925.

Coding paths 1000-1010 have aggregate intra prediction costs associated with them. Coding path 1000 has aggregate intra prediction cost J_{A1}+J_{B1} 1015 associated with it, coding path 1005 has aggregate intra prediction cost J_{A1}+J_{B5} 1020 associated with it, and coding path 1010 has aggregate intra prediction cost J_{A3}+J_{B8} 1025 associated with it.

It is appreciated by one of ordinary skill in the art that aggregate intra prediction costs 1015-1025 are the lowest aggregate intra prediction costs that were computed between previous block A 900 and current block B 925. It is also appreciated by one of ordinary skill in the art that coding paths are formed between the subset of intra prediction modes associated with the first block in a given macroblock all the way to the subset of intra prediction modes associated with the last block in a given macroblock. Selecting intra prediction modes for predicting and coding each block in the given macroblock is simply a matter of selecting the coding path that yields the lowest overall aggregate intra prediction cost.

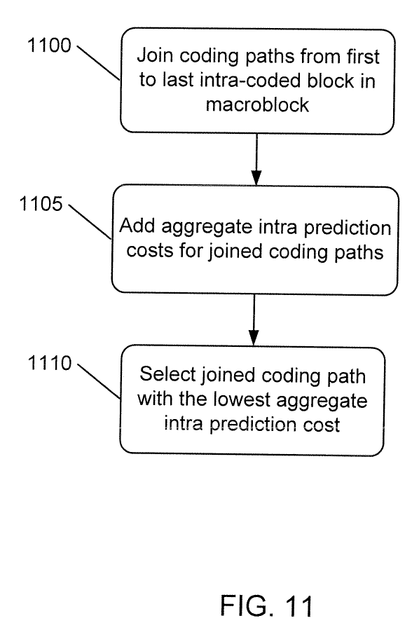

Referring now to FIG. 11, a flow chart for selecting an intra prediction mode for each block in an intra-coded macroblock in accordance with an embodiment of the invention is described First, coding paths from the first to the last block in the intra-coded macroblock are joined in step 1100. Then, the aggregate intra prediction costs for the joined coding paths are added in step 1105. The joined coding path with the lowest aggregate intra prediction cost is then selected as the final coding path in step 1110.

It is appreciated that for a subset having M intra prediction modes, there are a total of M joined coding paths as each intra prediction mode in a subset selected for a current block is associated via a coding path with one intra prediction mode in the subset selected for its corresponding previous block. For example, in the case where M=3, a total of 3 joined coding paths are available. The joined coding path presenting the lowest aggregate intra prediction cost is selected as the final coding path.

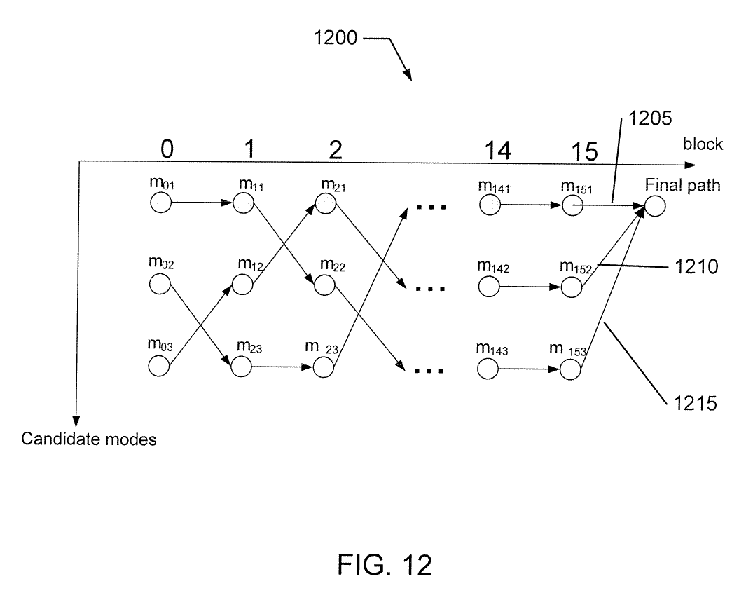

Referring now to FIG. 12, a schematic diagram showing coding paths in a macroblock in accordance with an embodiment of the invention is described. Diagram 1200 shows three joined coding paths 1205-1215 for a subset of three intra prediction modes for each block 0-15 in a given intra-coded macroblock containing 16 intra-coded blocks. A final coding path is selected out of the three coding paths 1205-1215, for example, coding path 1210, as the coding path yielding the lowest overall aggregate intra prediction cost. The intra-coded blocks 0-15 are then predicted and coded with the intra prediction modes associated with the joined coding path.

It is appreciated that by jointly selecting the intra prediction modes for all the blocks in the macroblock, that is, by selecting the intra prediction modes from the joined coding path that yields the lowest aggregate intra prediction cost, the intra mode decision for coding a video sequence is not just locally optimized as in traditional prior art approaches, but rather, it is globally optimized for the entire macroblock.

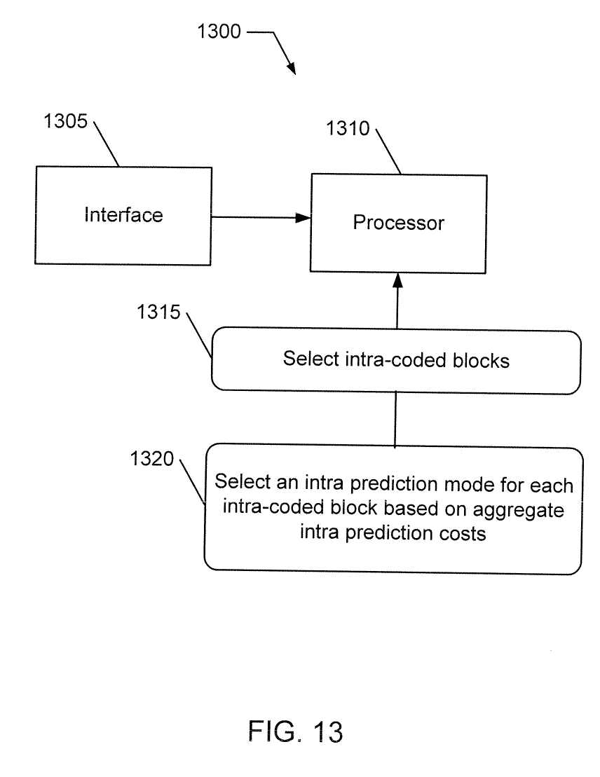

Referring now to FIG. 13, a block diagram of a video coding apparatus in accordance with an embodiment of the invention is described. Video coding apparatus 1300 has an interface 1305 for receiving a video sequence and a processor 1310 for coding the video sequence. Interface 1305 may be, for example, an image sensor in a digital camera or other such image sensor device that captures optical images, an input port in a computer or other such processing device, or any other interface connected to a processor and capable of receiving a video sequence.

In accordance with an embodiment of the invention and as described above, processor 1310 has executable instructions or routines for coding the received video sequence by using intra prediction. For example, processor 1310 has a routine 1315 for selecting frames, macroblocks, and blocks in the video sequence to be intra-coded by using intra prediction and a routine 1320 for selecting an intra prediction mode for each intra-coded block based on aggregate intra prediction costs computed relative to a subset of intra prediction modes for a corresponding previous intra-coded block.

It is appreciated that video coding apparatus 1300 may be a stand-alone apparatus or may be a part of another device, such as, for example, digital cameras and camcorders, hand-held mobile devices, webcams, personal computers, laptops, mobile devices, personal digital assistants, and the like.

Advantageously, the present invention enables intra prediction to be performed globally in a macroblock to achieve high-quality video sequences. In contrast to traditional intra prediction approaches, the intra prediction modes selected for the macroblock are jointly selected between the blocks. In doing so, the intra mode decision is not just locally optimized as in the traditional prior art approaches, but rather, it is globally optimized for the entire macroblock, thereby achieving superior rate-distortion performance for the entire video sequence.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. A computer readable storage medium, comprising executable instructions to:
select a plurality of blocks in a video sequence to be coded as intra-coded blocks;
compute aggregate intra prediction costs for each intra-coded block relative to a corresponding previous intra-coded block; and
select an intra prediction mode for each intra-coded block based on the aggregate intra prediction costs.

2. The computer readable storage medium of claim 1, wherein the video sequence comprises a plurality of intra-coded frames, each intra-coded frame comprising a plurality of macroblocks.

3. The computer readable storage medium of claim 2, wherein the executable instructions to select a plurality of blocks in a video sequence to be coded as intra-coded blocks comprise executable instructions to select the intra-coded blocks from a macroblock.

4. The computer readable storage medium of claim 1, further comprising executable instructions to select a subset of intra prediction modes for the corresponding previous intra-coded block.

5. The computer readable storage medium of claim 4, further comprising executable instructions to compute intra prediction costs for the subset of intra prediction modes for the corresponding previous intra-coded block.

6. The computer readable storage medium of claim 5, wherein the executable instructions to compute aggregate intra prediction costs for each intra-coded block comprise executable instructions to compute intra prediction costs for a plurality of intra prediction modes selected for the each intra-coded block.

7. The computer readable storage medium of claim 6, wherein the aggregate intra prediction costs comprise the intra prediction costs for the subset of intra prediction modes for the corresponding previous intra-coded block added to the intra prediction costs for the plurality of intra prediction modes selected for the each intra-coded block.

8. The computer readable storage medium of claim 7, further comprising executable instructions to select a subset of intra prediction modes for each intra-coded block that result in the lowest aggregate intra prediction costs for each intra-coded block.

9. The computer readable storage medium of claim 8, further comprising executable instructions to form a coding path between each intra prediction mode in the subset of intra prediction modes for each intra-coded block and one intra prediction mode in the subset of intra prediction modes for the corresponding previous block, the one intra prediction mode resulting in the lowest aggregate intra prediction cost for the each intra prediction mode in the subset of intra prediction modes for the each intra-coded block.

10. The computer readable storage medium of claim 9, wherein each coding path is associated with an aggregate intra prediction cost.

11. The computer readable storage medium of claim 10, further comprising executable instructions to form a subset of macroblock coding paths by joining the coding paths between each intra prediction mode in the subset of intra prediction modes for each intra-coded block and the one intra prediction mode in the subset of intra prediction modes for the corresponding previous block from a first intra-coded block to a last intra-coded block in the macroblock.

12. The computer readable storage medium of claim 1, further comprising executable instructions to compute a subset of macroblock aggregate intra prediction costs by adding the aggregate intra prediction costs associated with each coding path for each macroblock coding path in the subset of macroblock coding paths.

13. The computer readable storage medium of claim 12, wherein the executable instructions to select an intra prediction mode for each intra-coded block comprises executable instructions to select the macroblock coding path with the lowest macroblock aggregate intra prediction cost.

14. The computer readable storage medium of claim 8, wherein the subset of intra prediction modes for each intra-coded block comprises at least two intra prediction modes.

15. A method for selecting intra prediction modes for intra-coded blocks in a video sequence, comprising:
computing aggregate intra prediction costs associated with a plurality of intra prediction modes for each current intra-coded block relative to a subset of intra prediction modes for a corresponding previous intra-coded block;
selecting a subset of intra prediction modes for each current intra-coded block based on the aggregate intra prediction costs; and
determining an intra prediction mode from the subset of intra prediction modes for each intra-coded block that yields a smallest total aggregate intra prediction cost.

16. The method of claim 15, wherein computing aggregate intra prediction costs comprises:
computing intra prediction costs for each intra prediction mode in the subset of intra prediction modes for the corresponding previous intra-coded block;
computing intra prediction costs for the plurality of intra prediction modes for each current intra-coded block; and
adding the intra prediction costs for each intra prediction mode in the plurality of intra prediction modes for each current intra-coded block to the intra prediction costs for each intra prediction mode in the subset of intra prediction modes for the corresponding previous intra-coded block.

17. The method of claim 16, further comprising determining the smallest aggregate intra prediction cost for each intra prediction mode in the plurality of intra prediction modes.

18. The method of claim 17, further comprising forming a coding path between each intra prediction mode in the plurality of intra prediction modes and an intra prediction mode in the subset of intra prediction modes for the corresponding previous intra-coded block that yields the smallest aggregate intra prediction cost.

19. The method of claim 18, wherein selecting the subset of intra prediction modes for each current intra-coded block comprises selecting at least two intra prediction modes from the plurality of intra prediction modes for each current intra-coded block having the smallest aggregate intra prediction costs.

20. The method of claim 19, further comprising storing the coding paths for the at least two intra prediction modes in the subset of intra prediction modes for each current intra-coded block.

21. The method of claim 20, wherein the total aggregate intra prediction cost comprises the sum of the aggregate intra prediction costs of all stored coding paths for all intra-coded blocks in a macroblock of the video sequence.

22. A video coding apparatus, comprising:
an interface for receiving a video sequence; and
a processor for coding the video sequence, comprising executable instructions to
select a plurality of blocks in the video sequence to be coded as intra-coded blocks; and
select an intra prediction mode for each intra-coded block based on an aggregate intra prediction cost computed relative to a subset of intra prediction modes for a corresponding previous intra-coded block.

23. The video coding apparatus of claim 22, wherein the processor comprises executable instructions to code the video sequence in compliance with the H.264 video coding standard.

24. The video coding apparatus of claim 22, wherein the intra-coded blocks comprise 4×4 intra-coded blocks from a given 16×16 macroblock.

25. The video coding apparatus of claim 23, wherein the subset of intra prediction modes comprise at least two intra prediction modes out of nine intra prediction modes specified in the H.264 video coding standard.
